(19) United States
(12) Patent Application Publication
(10) Pub. No.: US 2011/0146434 A1
(43) Pub. Date: Jun. 23, 2011

(54) JACK SHAFT DISCONNECT

(76) Inventors: Keith E. Short, Rockford, IL (US); Michael F. Cass, Rockford, IL (US); Michael R. Blewett, Stillman Valley, IL (US)

(21) Appl. No.: 12/792,849

(22) Filed: Jun. 3, 2010

Related U.S. Application Data
(60) Provisional application No. 61/284,454, filed on Dec. 18, 2009.

(51) Int. Cl. F16H 57/02; F16D 1/06

(52) U.S. Cl. 74/405; 74/606 R

(57) ABSTRACT

A gearbox for an aircraft has a first side wall, a second side wall, a gear train, and an aircraft accessory. The aircraft accessory has a housing, an input attaching to the gear train for receiving rotative input from the gear train, and a first shaft for selectively coupling and uncoupling the gear train from the input. The housing attaches to the first side wall and the second side wall.

### RELATED APPLICATION

This application claims priority to U.S. Provisional Application No. 61/284,454, filed Dec. 18, 2009.

### BACKGROUND OF THE INVENTION

An aircraft's power requirements for various flight systems and passenger comfort are usually provided by a gas turbine engine. Such systems and accessories may include a fuel pump, engine lube pump, an electrical generator and a PMA, a small permanent magnet alternator (“PMA”) that provides power for electrical systems. The gas turbine engine can be an engine that provides thrust to the aircraft, an auxiliary power unit (“APU”) or both in some instances.

A conventional arrangement for transferring rotational energy from the gas turbine engine to accessories is by means of a geared transmission. Usually, the accessories mount on the face of an accessory gear box. The accessory gear box is often connected to a rotative engine output by beveled gearing. An accessory mounting gear box usually includes a drive shaft extending from gearing connected to the engine core and the drive shafts rotating the engine lube pump, fuel pump, the engine control, hydraulic pumps, generators etc.

Some accessories are needed for engine operation and must be highly reliable so that the engine maintains propulsive power. For instance, the PMA is used to power the electrical controls for the engine. Other accessories are not essential loads for flight, and mechanical disconnects are often incorporated inside the accessory to allow manual or automatic decoupling of the accessory drive shaft should the accessory malfunction. The decoupling of a faulty accessory reduces damage to the accessory that would occur with continued operation, and prevents overloads of the drive line should the accessory damage progress to shaft seizure. Some accessories incorporate shear sections that fracture and stop accessory rotation should a fault (such as a bearing failure inside the accessory) develop inside the accessory that exceeds normal operating torque.

### SUMMARY OF THE INVENTION

According to an exemplary embodiment herein, a gearbox for an aircraft has a first side wall, a second side wall, a gear train, and an aircraft accessory. The aircraft accessory has a housing, an input attaching to the gear train for receiving rotative input from the gear train, and a first shaft for selectively coupling and uncoupling the gear train from the input. The housing attaches to the first side wall and the second side wall.

According to a further exemplary embodiment herein, a gearbox has a first side wall, a second side wall, a gear train, and an accessory driven by the gear train. The accessory has a housing, an input attaching to the gear train for receiving rotative input from the gear train, and a first shaft for selectively coupling and uncoupling the gear train from the input. The housing attaches to the first side wall and the second side wall.

These and other features of the present invention can be best understood from the following specification and drawings, the following of which is a brief description.

### BRIEF DESCRIPTION OF THE DRAWINGS

FIG. 1 shows a prior art arrangement of a gear train coming from an engine such as an engine that provides thrust or an auxiliary power unit.

FIG. 2 shows an accessory such as a generator wherein the housing of the generator is degraded with a housing of the gearbox.

FIG. 3 shows a first embodiment of a jack shaft gearing arrangement incorporating a disconnect.

FIG. 4 is a second embodiment of a jack shaft as disclosed herein.

FIG. 5 is a still further embodiment of a jack shaft as provided herein.

### DETAILED DESCRIPTION OF THE PREFERRED EMBODIMENT

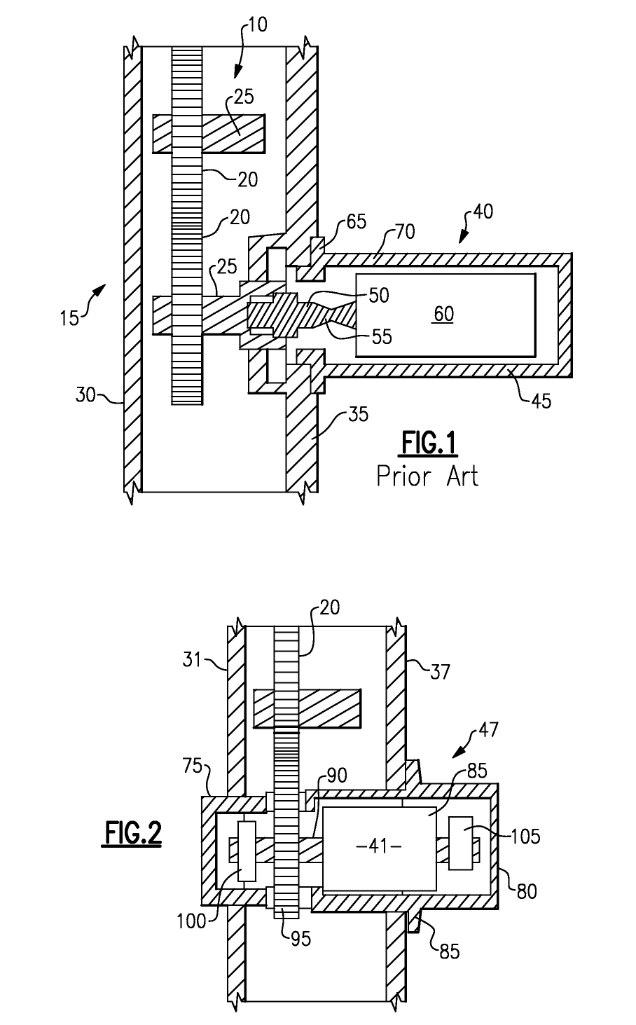

Referring now to FIG. 1, a prior art gear train 10 is shown within a gearbox 15. The gear train 10 has a plurality of gears 20 mounted on a plurality of rotating shafts 25. The gearbox 15 has a wall 30 and a wall 35 in which the gears 20 are mounted. The right wall 35 is reinforced and a heavier gauge is shown herein, to support an accessory 40 that projects from outside the right wall 35.

The accessory 40 may be mounted in a housing 45 and includes an accessory input shaft 50, a shear neck 55 and a rotating device 60 in the accessory 40. The accessory can be any of an engine lube pump, a fuel pump, a PMA, engine hydraulic pumps, and generators, etc. Though the accessory 40 shown herein is supported by the right wall 35 of the gearbox 15, an accessory can hang off of either side of the gearbox 15 so long as that side of the gearbox 15 is reinforced to hold that accessory 40 securely. The accessory housing 45 has an L-shaped flange 65 extending from a cylindrical body 70 to attach securely to the right wall 35. The L-shaped flange 65 and the right wall 35 are reinforced to support the hanging moment of the accessory 40 off the right wall 35.

To save generator and gearbox weight, an accessory such as a generator may be incorporated into a gearbox. This reduces the overhung moment of the generator which is normally cantilevered off of one face of the gearbox and allows the gearbox and generator to partially share the same housing. Reduced cantilever simplifies and allows the gearbox housing to be of lighter weight and may also reduce loads of a gearbox mount links, reducing their weight. Reduced cantilever and gearbox/accessory combined weight is a particular importance when the extreme engine dynamic load cases are considered that have many times a normal acceleration of gravity.

Referring now to FIG. 2, the accessory housing 47 is shown having a first portion 75 extending through the wall 31 and a second portion 80 extending through the right wall 37 of the gearbox 15. The weight of the accessory housing 45 is supported by both walls 30, 35 almost entirely normal to a longitudinal axis of each wall. As such, any torquing moment that requires the walls 30, 35 to be reinforced is eliminated thereby minimizing the weight of the gearbox walls because reinforcement may be reduced or eliminated. Moreover, because the accessory housing 45 also has a reduced torquing moment on it, flange 85, which attach by conventional means to the right wall 35, may not have to be reinforced, thereby further reducing weight.

In the embodiment shown in FIG. 2, an accessory 41 such as a generator or the like is supported on an input shaft 90 attaching to an input gear 95 which is driven by the gear train 10. The generator 41 may have several other components installed on the shaft 90 including a permanent magnet generator (“PMG”) 100 located outboard of the input gear 95 that provides power to an electronic controller (not shown) or the like, and an exciter 105 located on the right side of the accessory 41. The shaft 90 is supported on bearings within the housing 47.

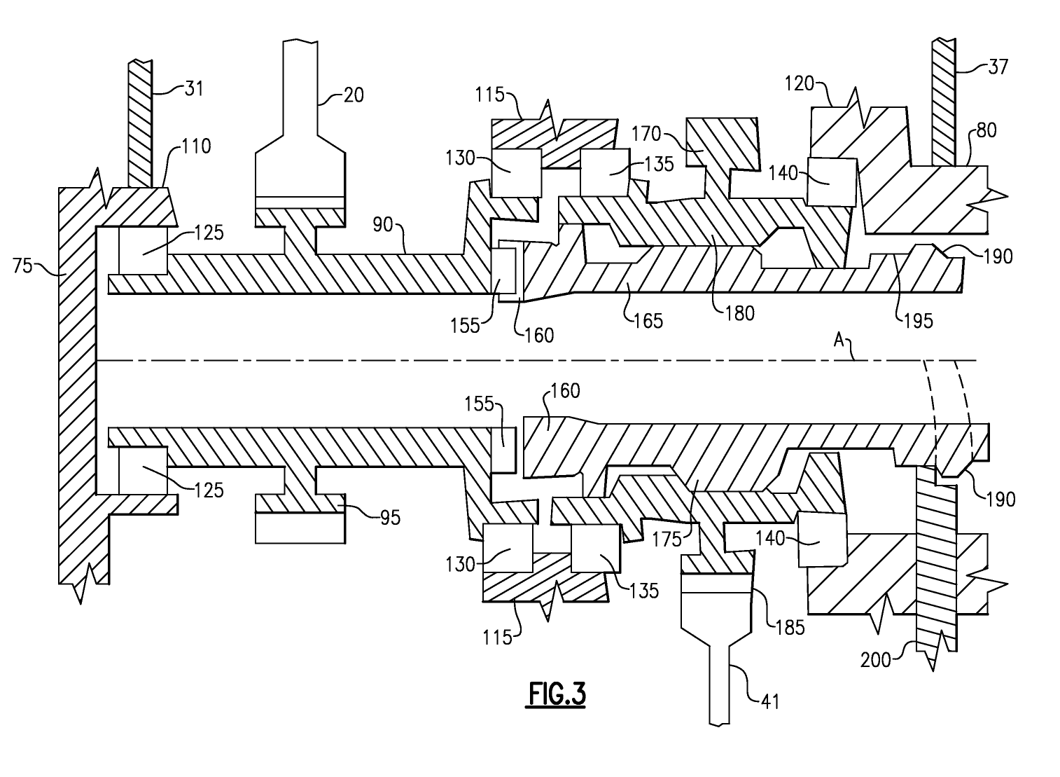

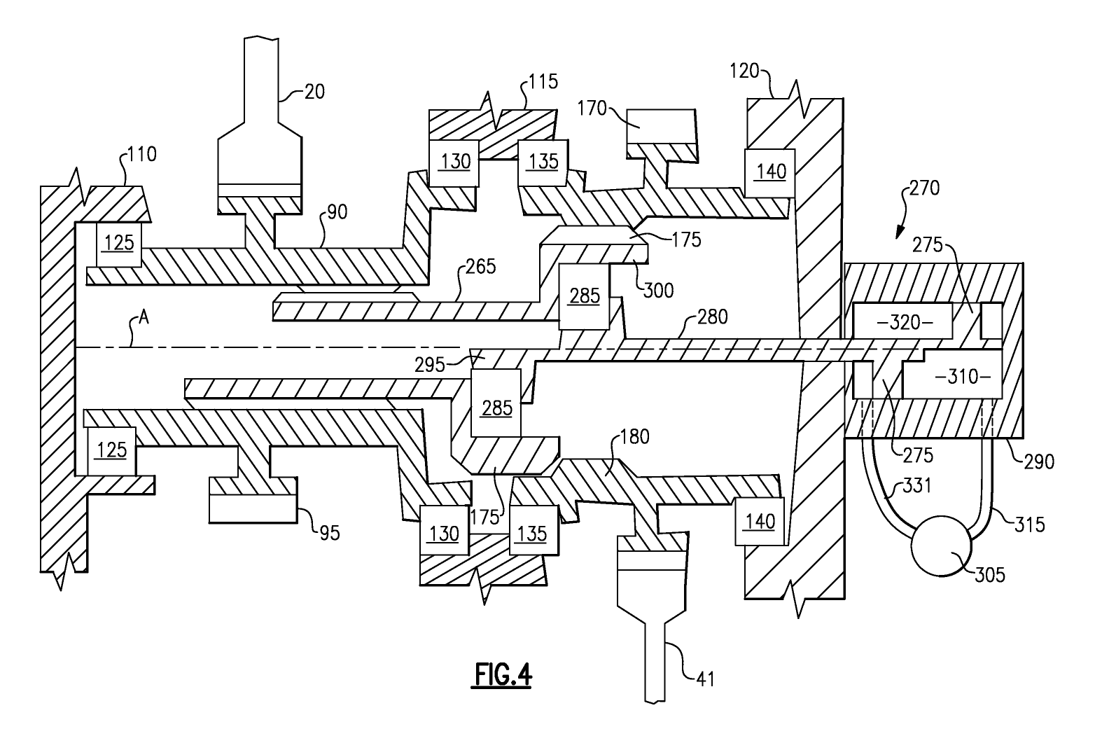

Referring now to FIG. 3, an embodiment is shown in an engaged position above Axis A and a disengaged position below Axis A (as is also true in the subsequent drawings). It should be appreciated that the split view of the Axis A is for illustrative purposes only and that the parts shown herein are in register with each other above and below Axis A if the embodiment is in either the engaged or disengaged position. Referring now to FIG. 3, portion 110 that attaches to wall 31 extending from first portion 75, portion 115 extending from a middle of body 70, and portion 120 extending from the second portion 80 and attaches to wall 37 are shown supporting a plurality of bearings, 125, 130, 135, and 140. A shaft 90 rotatively mounted between bearings 125 and 130 supports input gear 95 and rotates therewith that meshes with a gear in a gear train 10 as is known in the art. The shaft 90 has a plurality of axially teeth 155 that engage with axial teeth 160 (see above axis A) connected to a jack shaft 165 that is disposed within and engages an output gear 170. The jack shaft 165 has a plurality of jack shaft splines 175 that engage internal splines 180 of the output gear 170 shaft which is supporting by bearings 135, 140. The output gear 170 has teeth 185 that mesh with teeth (not shown) depending from a gear (not shown) that drives an accessory 41 such as a generator or the like.

The jack shaft 165 has a spiral ramp 190 disposed on extension 195 that extends beyond bearings 140. A disengagement pawl 200 is arranged transversely to the spiral ramp 190. Should the disengagement pawl 200 be pushed upwardly into engagement with the spiral ramp 190, the jack shaft 165 moves axially with the rotation of the spiral ramp 190 to the right in the drawing (see below Axis A in FIG. 3) to disengage its axial teeth 160 from the axial teeth 155 extending from the input shaft 90 to disconnect the accessory 41 from the input gear train 10. Input gear 95 and shaft 90 rotate freely without providing input to the accessory 41 through the jack shaft 165. The disengagement pawl 200 may be driven by a mechanical, electrical or hydraulic means acting in response to a signal received by a controller (not shown) in response to a stimulus that the accessory 41 is malfunctioning and should be withdrawn from gear train 20 to minimize damage to the accessory 41 or overloading of the gear train 20.

Referring now to FIG. 4, a jack shaft 265 is shown attaching to a hydraulic or pneumatic actuator 270, or the like (e.g., an electromechanical device such as a solenoid), via piston head 275, piston rod 280 and bearing 285. The jack shaft 265, instead of disconnecting from the axial teeth 155 (see FIG. 3) of the input shaft 90, disconnects from the output gear 170 by moving axially along the axis of rotation A as urged by the actuator 270 as will be discussed herein.

The actuator 270 has the piston head 275 disposed within a cylinder 290 outside of the second portion 80 in line with the axis of rotation A. The piston rod 280 extends from the actuator 270 through the second portion 80 and engages the jack shaft 265 via the bearing 285 that attaches to an outer end 295 of the piston rod 280 and an inner end 300 of the jack shaft 265. To disengage the jack shaft 265 from the output gear 170, a pump 305 impels fluid such as air or hydraulic fluid, into the right side 310 of the cylinder 290 via line 315 while drawing fluid from the left side of the cylinder 290 via line 331. The piston head 275 is driven axially to the left (see below the Axis A) and in turn drives the piston rod 280, the bearing 285 and the jack shaft splines 175 out of engagement with the interior spline teeth 180 of the output gear thereby protecting the accessory from continued input torque. To reverse the effect, (recouple the shaft) the pump 305 impels fluid into the left side 320 of the cylinder 290 while drawing fluid from the right side 310. The piston head 275 is driven axially to the right and in turn drives the piston rod 280, the bearing 285 and the jack shaft splines 175 re-engage the interior spline teeth 180 of the output gear.

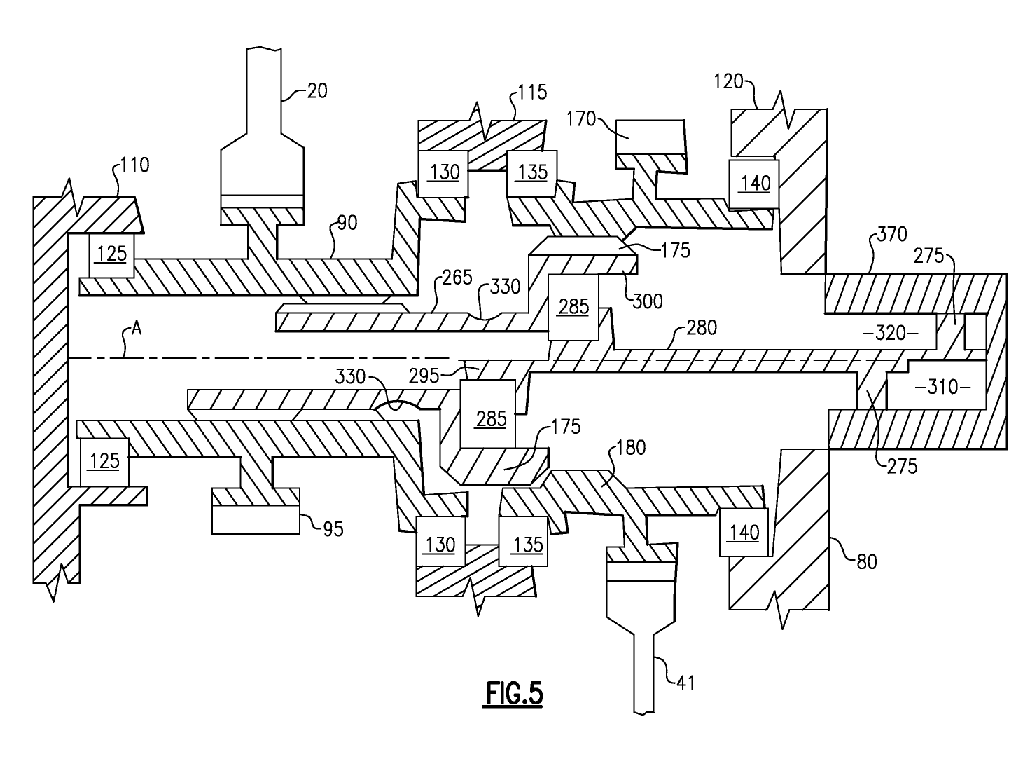

Referring now to FIG. 5, the jack shaft 265 is shown having a shear section 330 having a smaller diameter than the rest of the jack shaft 265. In extreme situations, where the pneumatic actuator or the disengagement paw do not act quickly enough to disengage the accessory from the input torque of the gear train 20, the shear section 330 protects the accessory 41 (see FIG. 2) from catastrophic situations by breaking before the accessory 41 does. Upon breaking, the jack shaft 265 has separate sections that rotate independently of each other there by stopping the accessory from rotation and potential breakage thereof. The shearing force necessary to cause the shear section 330 to break is normally greater than three times the maximum operating load. For instance, if the maximum operating load is 113 newton meters the shear section will break at about 339 newton meters. The ratio of three times the maximum operating load is suggested to avoid nuisance shearing where sudden unexpected loads that occur normally are encountered.

Referring further to FIG. 5, a hydraulic or pneumatic actuator 370, or the like is shown as an integral component of the second portion 80 of the housing 47.

Though the input shaft 90 (see also gear from the gear train 20 is shown on the left and the output gear 170 to the accessory 41 is shown to the right in the drawings, one of ordinary skill would recognize that the input shaft 90 could be on the right and the output gear 170 could be on the left depending on the requirements of the application. Moreover, the actuator 270 may be used with the embodiment shown in FIG. 3 and the spiral ramp 190 of FIG. 3 may be used to move the piston rod 280 of FIGS. 3 and 4.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A gearbox for an aircraft, said gearbox comprising:
a first side wall;
a second side wall;
a gear train; and
an aircraft accessory, said aircraft accessory comprising:
a housing;
an input attaching to said gear train for receiving rotative input from said gear train; and
a first shaft for selectively coupling and uncoupling said gear train from said input,
wherein said housing attaches to said first side wall and said second side wall.

2. The gearbox of claim 1 wherein said housing extends through said first side wall.

3. The gearbox of claim 2 wherein said housing extends through said second wall.

4. The gearbox of claim 1 wherein said input comprises:
an input gear attaching to a second shaft.

5. The gearbox of claim 4 wherein said first shaft includes first teeth for engaging said second shaft and second teeth for engaging an output shaft.

6. The gearbox of claim 5 wherein said output shaft engages an input to said aircraft accessory.

7. The gearbox of claim 1 wherein said first shaft includes a spiral ramp.

8. The gearbox of claim 1 wherein said spiral ramp cooperates with a pawl for moving said first shaft out of engagement with said gear train.

9. The gearbox of claim 8 wherein said first shaft moves axially.

10. The gearbox of claim 1 wherein said first shaft attaches to an actuator outside of said housing for translating said first shaft axially to engage and disengage from said input.

11. The gearbox of claim 10 wherein said actuator is hydraulically or pneumatically driven.

12. The gearbox of claim 1 wherein said first shaft attaches to an actuator that forms a part of said housing.

13. The gearbox of claim 1 wherein said input includes a gear rotating about a second shaft said second shaft rotating said first shaft.

14. The gearbox of claim 13 further including an actuator having a rod attaching to said first shaft for moving said first shaft axially out of engagement with said second shaft.

15. The gearbox of claim 13 further including an actuator having a rod attaching to said first shaft for moving said first shaft axially out of engagement with an output gear.

16. The gearbox of claim 15 wherein said first shaft rotates about said rod upon bearings.

17. The gearbox of claim 1 wherein said first shaft has teeth for engaging an output gear.

18. The gearbox of claim 17 wherein said output gear attaches to said aircraft accessory.

19. A gearbox, said gearbox comprising:
a first side wall;
a second side wall;
a gear train; and
an accessory driven by said gear train, said accessory comprising:
a housing;
an input attaching to said gear train for receiving rotative input from said gear train; and
a first shaft for selectively coupling and uncoupling said gear train from said input,
wherein said housing attaches to said first side wall and said second side wall.
